(19) United States
(12) Patent Application Publication
(10) Pub. No.: US 2007/0042070 A1
(43) Pub. Date: Feb. 22, 2007

(54) Shell Attachment Means For Blow Molding Machines

(76) Inventor: Mark Hallink, Cambridge (CA)

Correspondence Address: HODGSON RUSS LLP, ONE M & T PLAZA, SUITE 2000, BUFFALO, NY, 14203-2391, US

(21) Appl. No.: 11/460,707

(22) Filed: Jul. 28, 2006

Related U.S. Application Data
(60) Provisional application No. 60/703,161, filed on Jul. 28, 2005.

(51) Int. Cl. B29C 33/00

(52) U.S. Cl. 425/195

(57) ABSTRACT

A molding machine has mating mold halves movable relative to each other, each comprising a shell and a shell holder, carried by a mold carrier, the shell holder being formed with a hollowed out portion shaped to accept the shell therein and orient the shell for mating with the shell of the other mold half when the mold halves are brought together; each shell including a facial cavity which defines a half shape of the article to be made, such that when the shells of the mating mold halves are brought together, the facial cavities of each shell form a cavity therebetween which forms the shape of the article to be made, each said shell having attached thereto along a side edge portion thereof, a retainer piece, said retainer piece including an attachment portion extending outwardly from the shell over an adjacent portion of the shell holder, wherein when said shell is positioned in said hollowed out portion, the attachment portion is positioned to be secured to said adjacent portion of the shell holder. Alternately the shell may be attached directly to the mold carrier in a similar manner.

### CROSS-REFERENCE TO RELATED APPLICATION

The present application claims priority to U.S. Provisional Patent Application No. 60/703,161 filed Jul. 28, 2005, entitled “Non Quick Change Shell Attachment Means For Blow Molding Machines”, which is incorporated herein by reference.

### FIELD OF THE INVENTION

This invention relates to molding machines used to produce thermoplastic articles such as bottles by means of stretch blow molding (SBM), extrusion blow molding (EBM) or injection blow molding (IBM) and in particular to improved means of attaching mold shells to shell holders and/or mold carriers in such molding machines.

### BACKGROUND OF THE INVENTION

Known molding machines comprise at least one mold which consists of two mating mold halves, supported by a mold carrier (also referred to as a platen or machine platen). The mold carriers move the mold halves relative to each other. When the mating mold halves are brought together by the mold carrier, the cavity formed between mating faces of the mold halves forms the shape of the desired article to be formed, which is typically a bottle made from blow molding (thermoplastic SBM, EBM, or IBM) of a preheated thermoplastic preform or parison.

To allow articles of different shapes and sizes to be formed and to allow the mold halves to be repaired or replaced if they become worn or damaged, it is known to have the mold halves or portions thereof be removably secured to the mold carriers.

### SUMMARY OF THE INVENTION

It is an object of the invention to provide an improved means for the fastening or attachment of a half round mold shell cavity assembly (shell) within a half-round (shell-holder) or directly to the carrier in an SBM, EBM or IBM machine.

In accordance with an aspect of the invention there is provided a molding machine comprising mating mold halves movable relative to each other, each mold half comprising a shell and a shell holder, which are carried by a mold carrier, the shell holder being formed with a hollowed out portion shaped to accept the shell therein and orient the shell for mating with the shell of the other mold half when the mold halves are brought together; each shell including a facial cavity which defines a half shape of the article to be made, such that when the shells of the mating mold halves are brought together, the facial cavities of each shell form a cavity therebetween which forms the shape of the article to be made, each said shell having attached thereto along a side edge portion thereof, a retainer piece, said retainer piece including an attachment portion extending outwardly from the shell over an adjacent portion of the shell holder, wherein when said shell is positioned in said hollowed out portion, said attachment portion is positioned to be secured to said adjacent portion of the shell holder by fastening means.

In accordance with a further aspect of the invention there is provided a molding machine comprising mating mold halves movable relative to each other, each mold half comprising a shell and a mold carrier, the carrier being formed with a hollowed out portion shaped to accept the shell therein and orient the shell for mating with the shell of the other mold half when the mold halves are brought together; each shell including a facial cavity which defines a half shape of the article to be made, such that when the shells of the mating mold halves are brought together, the facial cavities of each shell form a cavity therebetween which forms the shape of the article to be made, each said shell having attached thereto along a side edge portion thereof, a retainer piece, said retainer piece including an attachment portion extending outwardly from the shell over an adjacent portion of the carrier, wherein when said shell is positioned in said hollowed out portion, said attachment portion is positioned to be secured to said adjacent portion of the carrier by fastening means.

The invention herein provides the ability to fasten a shell mold (also referred to as a shell) within a shell holder or directly to a mold carrier of a molding machine in a positive/complete manner. The means provided additionally allows for some variability of the location of attachment of the shell to the shell holder and preserves the integrity of the shell as the attachment is made by an additional piece.

Other aspects and advantages of the invention, as well as the structure and operation of example embodiments of the invention, will become apparent to those ordinarily skilled in the art upon review of the following description of the invention in conjunction with the accompanying drawings.

### BRIEF DESCRIPTION OF THE DRAWINGS

FIG. 1 is a perspective view of a first embodiment of a half mold assembly (also referred to as a mold half) in accordance with the invention illustrating a shell secured within a shell holder; and

FIG. 2 is an exploded perspective view of the embodiment of the half mold assembly of FIG. 1, illustrating the shell prior to attachment to the shell holder.

FIG. 3 is a perspective view of a second embodiment of a half mold assembly (also referred to as a mold half) in accordance with the invention illustrating a shell secured directly within the shell holder/carrier; and

FIG. 4 is an exploded perspective view of the embodiment of the half mold assembly of FIG. 3, illustrating the shell prior to attachment to the generic shell holder/carrier.

### DESCRIPTION OF EXAMPLE EMBODIMENTS OF THE INVENTION

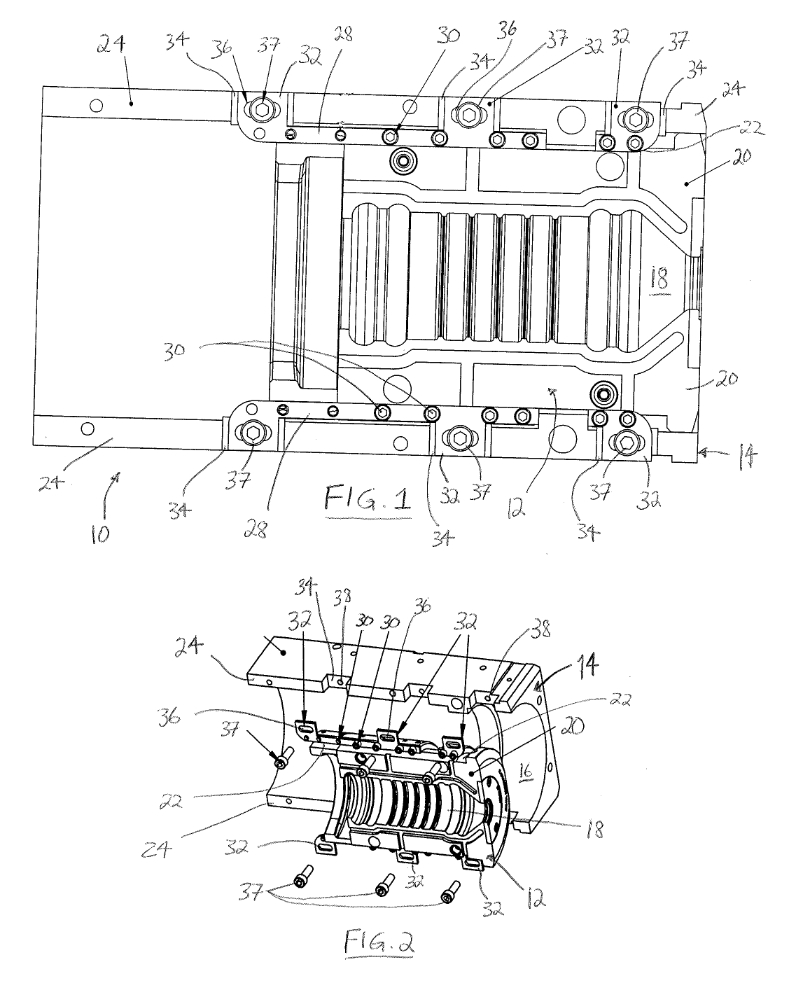

Shown in FIGS. 1 and 2 is a first example embodiment of a mold half 10 in accordance with the invention Shell Mold/Mold Shell (also referred to as shell) 12 is removably fastened to shell holder 14 as follows:

The shell holder 14 is formed with a hollowed out portion 16 which is shaped to accept the shell 12 sitting flush therein. In the embodiment shown, the shell 12 is of the half round variety, although any known shell 12 and shell holder 14 could be utilized. The hollowed out portion 16 is shaped such that the shell 12 sits flush therein. The shell 12 includes a centrally oriented facial cavity 18 which defines a half shape of the article to be made. The shell is positioned and oriented within the shell holder 14 in the hollowed out portion 16 such that face 20 of the shell can be mated against the face of the shell of the other mold halves when the mold halves are brought together by a mold carrier in any known manner, such that when the shell of the respective mold halves are brought together by the mold carrier (not shown in FIGS. 1 and 2), the cavity formed therebetween forms the shape of the article, at which point the thermoplastic preform or parison may be stretch-blow molded, extrusion blow molded or injection blow molded to form the article.

To achieve attachment of the shell 12 to the shell holder 14 in a secure but removable manner, the shell sits in the shell holder such that side edge portions 22 of the shell 12 sit adjacent to front portion 24 of the shell holder 14. In the preferred embodiment the facial cavity 18 sits in a middle portion of the shell between side edge portions 22 of the shell 12. At least one side edge portion 22 of the shell, and preferably both side edge portions 22 have attached thereto on a portion of thereof, a retainer piece 28 or plurality of retainer pieces. Preferably each retainer piece 28 extends along opposite side edge portions 22 of the shell. The retainer piece 28 is itself attached to the shell in a positive manner, to the side edges portions 22 of the shell using an ordinary hardware component such as for example a socket head cap screws 30 or the like. Other securing means could be utilized to attach the retainer piece to the side edges of the shell, such as rivets, screws or the like. Each retainer piece 28 has at least one attachment portion 32 which extends laterally outwardly from the side edge portions 22 of the shell extending over the front portions 24 of the shell holder 14. Preferably, the attachment portions 32 are adapted to align with adjacent slotted portions (also referred to as recesses) 34 formed in the front portions 24 of shell holders when the shell 12 is inserted in the hollowed out portion of the shell holder 14 as seen in FIG. 1. Preferably each attachment portion 32 defines a slot 36 therein, through which a screw 37 or the like may be inserted. The screw is adapted to be inserted in a mating screw hole. 38 in the slotted portion 34 of the shell holder. When the shell is positioned, sitting flush in the hollowed out portion 16 of the shell holder, the attachment portions 32 of retainer piece(s) 28 are adapted to be fit in the respective slotted portions 34 of the shell holder whereat a positive attachment means such as a screw 37 (illustrated as a socket head cap screw) or the like may inserted through the slot 36 in the attachment portion 32 and into a screw hole 38 in the shell holder. It should be understood that the retainer piece could be attached at various positions along the side edge portions of the shell and the attachment portion 32 may be shaped and positioned to extend over the shell holder to be attached at various locations thereto, and not necessarily in the slotted portions shown in the figures, so long as it extends over a portion of the shell holder to allow attachment thereto.

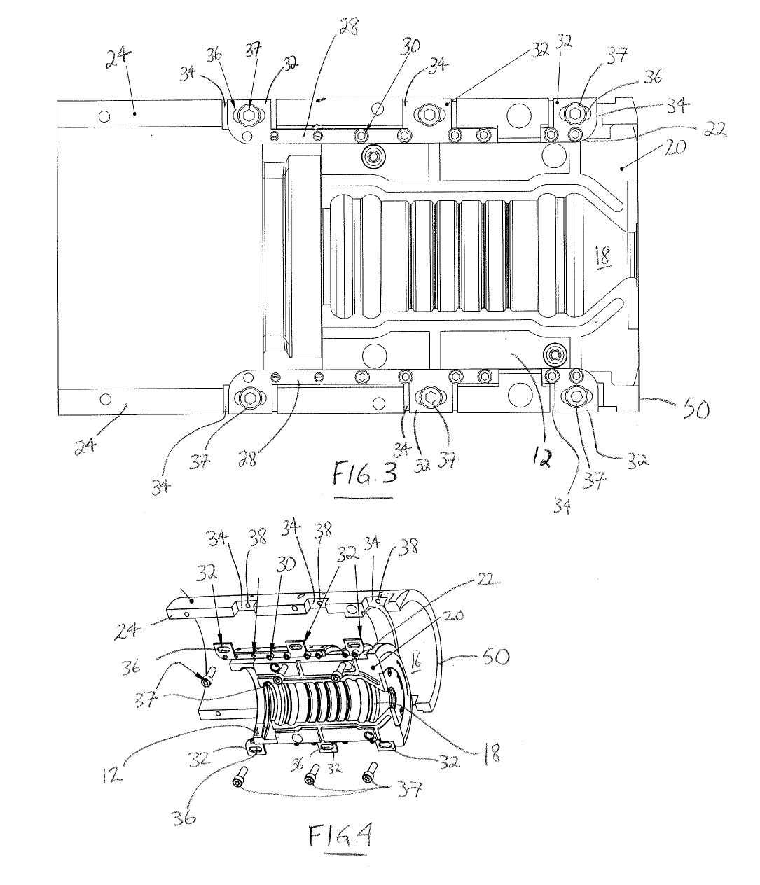

As shown in FIGS. 3 and 4, the shell 12 may be attached directly to carrier (also referred to as platen) 50 in a similar manner as the shell 12 attached to the shell holder 14 in FIGS. 1 and 2. The features of the shell 12 of FIGS. 3 and 4 are the same as described above and shown in FIGS. 1 and 2 and similar reference numerals are used in different figures to indicate similar features of the shell holder of FIGS. 1 and 2 and the carrier of FIGS. 3 and 4. In the embodiment of FIGS. 3 and 4, shell 12 is attached to the carrier 50 directly in a secure but removable manner. The shell 12 sits in the carrier 50 such that side edge portions 22 of the shell 12 sit adjacent to front portion 24 of the carrier 50. Retainer piece 28 has at least one attachment portion 32 which extends laterally outwardly from the side edge portions 22 of the shell extending over the front portions 24 of the carrier 50. Preferably, the attachment portions 32 are adapted to align with adjacent slotted portions 34 formed in the front portions 24 of carrier 50 when the shell 12 is inserted in the hollowed out portion of the carrier 50 as seen in FIG. 3. Preferably each attachment portion 32 defines a slot 36 therein, through which a screw 37 or the like may be inserted. The screw is adapted to be inserted in a mating screw hole 38 in the slotted portion 34 of the carrier 50. When the shell is positioned, sitting flush in the hollowed out portion 16 of the carrier, the attachment portions 32 of retainer piece(s) 28 are adapted to be fit in the respective slotted portions 34 of the carrier whereat a positive attachment means such as a screw 37 (illustrated as a socket head cap screw) or the like may inserted through the slot 36 in the attachment portion 32 and into a screw hole 38 in the shell holder. It should be understood that the retainer piece could be attached at various positions along the side edge portions of the shell and the attachment portion 32 may be shaped and positioned to extend over the carrier to be attached at various locations thereto, and not necessarily in the slotted portions shown in the figures, so long as it extends over a portion of the carrier to allow attachment thereto.

It should be understood that the retainer piece(s) 28 is/are removably attached to the shell 12. This allows for retainer pieces having different shapes and sizes of attachment portions to accommodate variations in the shape of slotted portions or positions of attachment to the shell holder or carrier. Furthermore by having the point of attachment be between the retainer piece and the shell holder or carrier as opposed to directly between the shell and shell holder or carrier, the wearing (and or possible cracking) on the shell itself is reduced for example by avoiding direct contact of moving parts such as sliding lugs and/or wide headed screws having to engage the shell itself. Thus, the use of an intermediate retainer piece provides a secure attachment, which reduces wear on the shell itself. Furthermore using an intermediate retainer piece which may have attachment portions of various sizes and shapes allows for attachment of the shell to shell holders or carriers having variations in the face thereof.

The above-described embodiments of the present invention are intended to be examples only. Alterations, modifications and variations may be effected to the particular embodiments by those skilled in the art without departing from the scope of the invention, which is defined by the claims appended hereto.

1. A molding machine comprising mating mold halves movable relative to each other, each mold half comprising a shell and a shell holder, the shell holder being formed with a hollowed out portion shaped to accept the shell therein and orient the shell for mating with the shell of the other mold half when the mold halves are brought together; each shell including a facial cavity which defines a half shape of the article to be made, such that when the shells of the mating mold halves are brought together, the facial cavities of each shell form a cavity therebetween which forms the shape of the article to be made, each said shell having attached thereto along a side edge portion thereof, a retainer piece, said retainer piece including an attachment portion extending outwardly from the shell over an adjacent portion of the shell holder, wherein when said shell is positioned in said hollowed out portion, said attachment portion is positioned to be secured to said adjacent portion of the shell holder by fastening means.

2. A molding machine as recited in claim 1 wherein said fastening means is a screw or rivet or the like inserted through mating holes in the attachment portion and shell holder.

3. A molding machine as recited in claim 2 wherein each said attachment portion is adapted to align with an adjacent slotted portion formed in the shell holder when the shell is inserted in the shell holder.

4. A molding machine comprising mating mold halves movable relative to each other, each mold half comprising a shell and a mold carrier, the carrier being formed with a hollowed out portion shaped to accept the shell therein and orient the shell for mating with the shell of the other mold half when the mold halves are brought together; each shell including a facial cavity which defines a half shape of the article to be made, such that when the shells of the mating mold halves are brought together, the facial cavities of each shell form a cavity therebetween forming the shape of the article to be made, each said shell having attached thereto along a side edge portion thereof, a retainer piece, said retainer piece including an attachment portion extending outwardly from the shell over an adjacent portion of the carrier, wherein when said shell is positioned in said hollowed out portion, said attachment portion is positioned to be secured to said adjacent portion of the carrier by fastening means.

5. A molding machine as recited in claim 4 wherein said fastening means is a screw or rivet or the like inserted through mating holes in the attachment portion and the adjacent portion of the carrier by fastening means.

6. A molding machine as recited in claim 5 wherein each said attachment portion is adapted to align with a slotted portion formed in the adjacent portion of the carrier when the shell is inserted in the carrier.
